(19) United States
(12) Patent Application Publication
(10) Pub. No.: US 2025/0348051 A1
(43) Pub. Date: Nov. 13, 2025

(54) RECORDING MEDIUM, SIMULATION DEVICE, AND SIMULATION SYSTEM

(71) Applicant: Mitsubishi Electric Corporation, Tokyo (JP)

(72) Inventors: Ryo KUYA, Tokyo (JP); Visol AHMED, Tokyo (JP)

(73) Assignee: Mitsubishi Electric Corporation, Tokyo (JP)

(21) Appl. No.: 18/861,237

(22) PCT Filed: Aug. 1, 2022
(86) PCT No.: PCT/JP2022/029446

§ 371 Date: Oct. 29, 2024

(51) Int. Cl. G05B 19/05

(52) U.S. Cl. CPC G05B 19/05; G05B 2219/13185

(57) ABSTRACT

A simulation program causes a computer to function as a configuration information acquirer that acquires configuration information generated based on a user operation and indicating a configuration of a virtual PLC system to simulate an operation of a PLC system, a builder that builds the virtual PLC system based on the configuration information, an assigner that assigns, to a virtual PLC included in the virtual PLC system indicated by the configuration information, an IP address and a port number of an unoccupied port of the computer, a designation request receiver that receives, from an engineering tool, a designation request designating a virtual PLC included in the virtual PLC system indicated by the configuration information, and a connection information responder that responds to the engineering tool with connection information including the IP address and the port number assigned to the virtual PLC designated in the designation request.

### TECHNICAL FIELD

The present disclosure relates to a simulation program, a simulation device, a simulation system, and a simulation method.

### BACKGROUND ART

In building a programmable logic controller (PLC) system in a factory automation (FA) system, simulation is performed to check the operation of a PLC program executed by a PLC. In the simulation, a virtual PLC that simulates the operation of the actual PLC is built on a computer and executes the PLC program written with an engineering tool into the virtual PLC.

Multiple virtual PLCs with the above configuration may be built on a single computer to which a single internet protocol (IP) address is assigned. Various techniques have been developed for the engineering tool to connect to the multiple virtual PLCs using the single IP address. For example, Patent Literature 1 describes a technique using multiple port numbers for the single IP address and assigning the port numbers to the virtual PLCs without any overlap.

### CITATION LIST

### Patent Literature

Patent Literature 1: Unexamined Japanese Patent Application Publication No. 2003-067036

### SUMMARY OF INVENTION

### Technical Problem

With the above technique, however, a user that performs the simulation is to manage information about the correspondence of the virtual PLCs with the IP address and the port numbers. The user is also to specify the IP address and the port number corresponding to a specific virtual PLC to connect to the specific virtual PLC with the engineering tool. Reduction of such procedural load involved in the simulation for ease of connection to the virtual PLC is required.

Under such circumstances, an objective of the present disclosure is to provide a simulation program, a simulation device, a simulation system, and a simulation method that can easily connect to a virtual PLC.

### Solution to Problem

To achieve the above objective, a simulation program according to an aspect of the present disclosure causes a computer to function as configuration information acquisition means for acquiring configuration information indicating a configuration of a virtual programmable logic controller (PLC) system to simulate an operation of a PLC system, building means for building the virtual PLC system based on the configuration information, assignment means for assigning, to a virtual PLC included in the virtual PLC system indicated by the configuration information, an internet protocol address of the computer and a port number of an unoccupied port of the computer, designation request receiving means for receiving, from an engineering tool, a designation request designating the virtual PLC included in the virtual PLC system indicated by the configuration information, and connection information response means for responding to the engineering tool with connection information including the internet protocol address and the port number assigned to the virtual PLC designated in the designation request.

### Advantageous Effects of Invention

The simulation program, the simulation device, the simulation system, and the simulation method according to the above aspect of the present disclosure can easily connect to a virtual PLC.

### BRIEF DESCRIPTION OF DRAWINGS

FIG. 1 is a diagram of a simulation system according to Embodiment 1;

FIG. 2 is a block diagram of an information processing device in Embodiment 1, illustrating the hardware configuration;

FIG. 3 is a functional block diagram of a simulation device according to Embodiment 1;

FIG. 4 is a diagram illustrating configuration information in Embodiment 1;

FIG. 5 is a diagram of a connection information table in Embodiment 1;

FIG. 6 is a flowchart of a building process in Embodiment 1;

FIG. 7 is a flowchart of a control process in Embodiment 1;

FIG. 8 is a diagram of a simulation system according to Embodiment 2;

FIG. 9 is a functional block diagram of a simulation device according to Embodiment 2;

FIG. 10 is a diagram illustrating configuration information in Embodiment 2;

FIG. 11 is a diagram of a connection information table in Embodiment 2;

FIG. 12 is a diagram of a simulation system according to Embodiment 3;

FIG. 13 is a functional block diagram of a simulation device according to Embodiment 3; and

FIG. 14 is a diagram of a connection information table in Embodiment 3.

### DESCRIPTION OF EMBODIMENTS

### Embodiment 1

A simulation system according to Embodiment 1 simulates a programmable logic controller (PLC) program in a virtual PLC system including at least one virtual PLC.

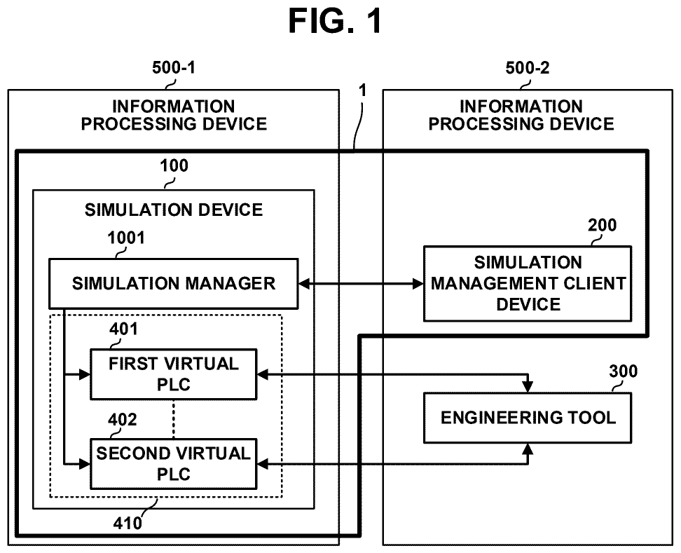

FIG. 1 illustrates a simulation system 1 according to the present embodiment. The simulation system 1 includes a simulation device 100 and a simulation management client device 200. The simulation device 100 is connected to the simulation management client device 200 and an engineering tool 300 with a network cable (not illustrated) or wirelessly to allow communication.

The simulation device 100 builds the virtual PLC system and simulates the operation of a PLC system. The simulation device 100 includes a simulation manager 1001 that exchanges information with the simulation management client device 200 and builds the virtual PLC system. The simulation manager 1001 also manages information about the virtual PLC.

The simulation device 100 receives, from the engineering tool 300, operations on the virtual PLC included in the virtual PLC system. For example, the simulation device 100 receives, from the engineering tool 300, the operation of writing a PLC program to be executed in a virtual PLC. The simulation device 100 executes the written PLC program in the virtual PLC.

The simulation management client device 200 receives an operation from the user and causes the simulation device 100 to build the virtual PLC system. The simulation management client device 200 has, for example, dedicated software for setting the configuration of the virtual PLC system installed. The user uses the dedicated software to set the configuration of the virtual PLC system, or uses a web browser of the simulation management client device 200 to set the configuration of the virtual PLC system.

The engineering tool 300 creates, based on an operation from the user, the PLC program to be executed in the virtual PLC system. The engineering tool 300 connects, based on an operation from the user, to a virtual PLC in the virtual PLC system built on the simulation device 100 and writes the PLC program into the connected virtual PLC.

In the present embodiment, as illustrated in FIG. 1, the simulation device 100 is implemented by an information processing device 500-1, and the simulation management client device 200 and the engineering tool 300 are implemented by an information processing device 500-2.

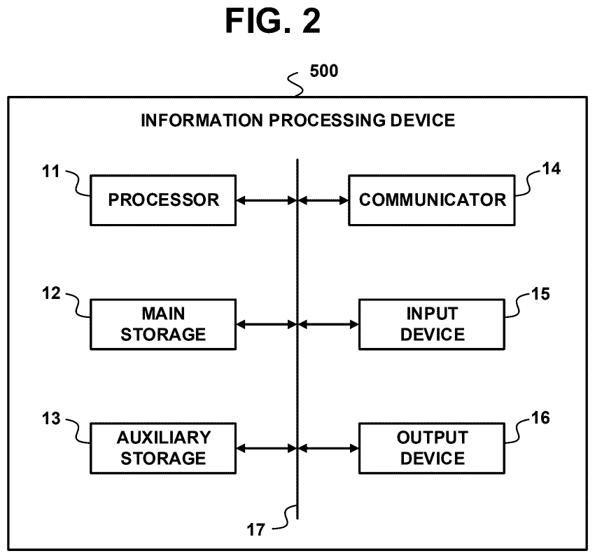

The information processing devices 500-1 and 500-2 illustrated in FIG. 1 and an information processing device 500-3 described later each have the hardware configuration of an information processing device 500 illustrated in FIG. 2.

The information processing device 500 includes a processor 11 that performs various processes, a main storage 12 used as a work area for the processor 11, an auxiliary storage 13 that stores various sets of data used for processing by the processor 11, a communicator 14 that communicates with an external device, an input device 15 that acquires information input, and an output device 16 that presents various items of information. The main storage 12, the auxiliary storage 13, the communicator 14, the input device 15, and the output device 16 are connected to the processor 11 with a bus 17.

The processor 11 includes a central processing unit (CPU). The processor 11 executes a program stored in the auxiliary storage 13 to implement various functions of the information processing device 500.

The main storage 12 includes a random-access memory (RAM). A program is loaded from the auxiliary storage 13 into the main storage 12. The main storage 12 is used as a work area for the processor 11.

The auxiliary storage 13 includes a nonvolatile memory such as an electrically erasable programmable read-only memory (EEPROM). The auxiliary storage 13 stores, in addition to the program, various sets of data used for processing by the processor 11. The auxiliary storage 13 provides, as instructed by the processor 11, data to be used by the processor 11 to the processor 11 and stores data provided by the processor 11.

The communicator 14 includes a network interface circuit for communicating with the external device. The communicator 14 receives a signal from the external device and outputs data indicated by the signal to the processor 11. The communicator 14 also transmits a signal indicating data output from the processor 11 to the external device.

The input device 15 includes an input device such as an input key or a pointing device. The input device 15 acquires information input by the user of the information processing device 500 and provides the acquired information to the processor 11.

The output device 16 includes an output device such as a liquid crystal display (LCD) or a speaker. The output device 16 may include a touchscreen integrated with a pointing device included in the input device 15. The output device 16 presents various items of information to the user as instructed by the processor 11.

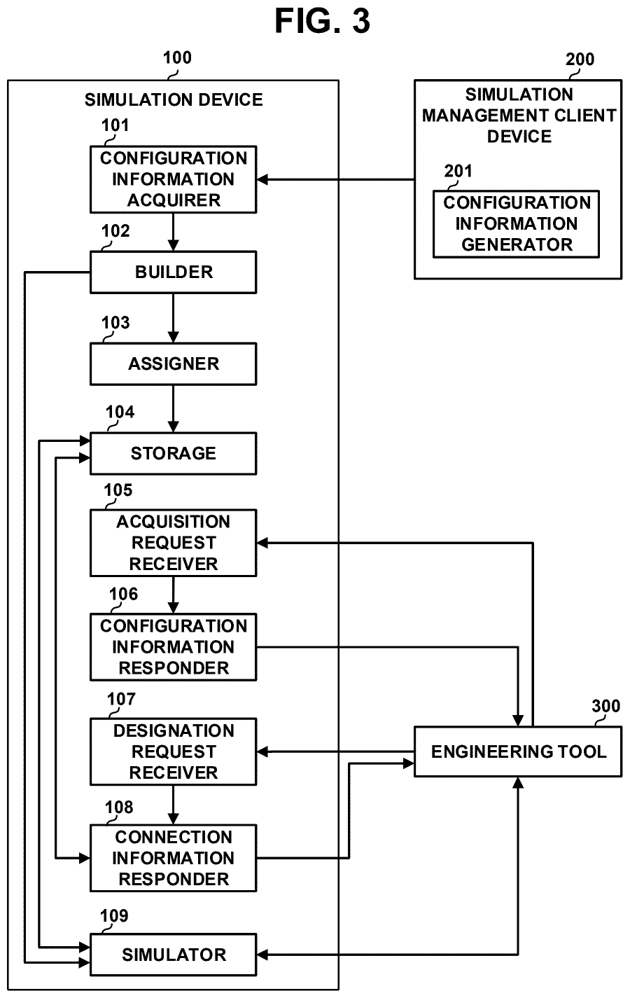

FIG. 3 illustrates functional components of the simulation device 100 and the simulation management client device 200 in the present embodiment.

The simulation device 100 functionally includes a configuration information acquirer 101 that acquires configuration information from the simulation management client device 200, a builder 102 that builds the virtual PLC system based on the configuration information, an assigner 103 that assigns an IP address and a port number to each virtual PLC included in the virtual PLC system, a storage 104 that stores connection information including the IP address and the port number assigned to each virtual PLC, an acquisition request receiver 105 that receives, from the engineering tool 300, an acquisition request for the configuration information, a configuration information responder 106 that responds to the engineering tool 300 with the configuration information, a designation request receiver 107 that receives, from the engineering tool 300, a designation request designating a virtual PLC, a connection information responder 108 that responds to the engineering tool 300 with the connection information about the virtual PLC designated in the designation request, and a simulator 109 that causes the built virtual PLC system to simulate an operation. The configuration information acquirer 101, the builder 102, the assigner 103, the storage 104, the acquisition request receiver 105, the configuration information responder 106, the designation request receiver 107, and the connection information responder 108 are the functions of the simulation manager 1001.

The simulation management client device 200 includes a configuration information generator 201 that generates the configuration information.

The configuration information acquirer 101 acquires the configuration information indicating the configuration of the virtual PLC system that simulates the operation of the PLC system. The configuration information acquirer 101 is implemented by the processor 11 and the communicator 14. The configuration information acquirer 101 is an example of configuration information acquisition means.

The configuration information is information indicating the configuration of the virtual PLC system such as the configuration of units included in the virtual PLC system or the network configuration.

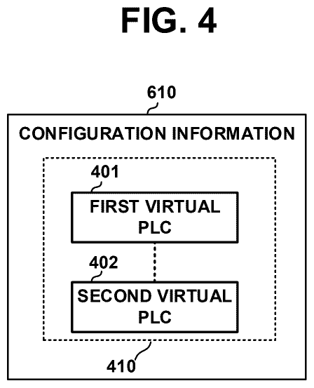

For example, the user creates configuration information 610 illustrated in FIG. 4 in the simulation management client device 200. The configuration information 610 is information indicating the configuration of a virtual PLC system 410 including a first virtual PLC 401 and a second virtual PLC 402. When the simulation management client device 200 transmits the configuration information 610 to the simulation device 100, the configuration information acquirer 101 acquires the configuration information 610.

The builder 102 builds the virtual PLC system based on the configuration information. The builder 102 is implemented by the processor 11. The builder 102 is an example of building means.

For example, as illustrated in FIG. 1, the builder 102 builds, based on the configuration information 610, the virtual PLC system 410 including the first virtual PLC 401 and the second virtual PLC 402 in the simulation device 100.

The assigner 103 assigns, to each virtual PLC included in the virtual PLC system indicated by the configuration information, the IP address of the information processing device 500-1 in which the simulation device 100 that builds the virtual PLC system is implemented and the port number of an unoccupied port of the information processing device 500-1. The assigner 103 is implemented by the processor 11. The assigner 103 is an example of assignment means.

For example, the IP address of the information processing device 500-1 is in “192.168.1.3”, and the port numbers of unoccupied ports of the information processing device 500-1 are “50001” to “50100”. In this case, the assigner 103 assigns the IP address of “192.168.1.3” and the port number of “50001” to the first virtual PLC 401, and the IP address of “192.168.1.3” and the port number of “50002” to the second virtual PLC 402. The port numbers may be assigned to the virtual PLCs included in the virtual PLC system with any method that assigns the port numbers of unoccupied ports without any overlap.

When assigning the IP address and the port number to each virtual PLC, the assigner 103 stores virtual-PLC identification information for identifying each virtual PLC and the connection information into the storage 104 in a manner associated with each other.

The connection information is information that is used to connect to the virtual PLC with the engineering tool 300 and includes the IP address and the port number in the present embodiment.

The storage 104 stores the virtual-PLC identification information and the connection information. The storage 104 is implemented by the auxiliary storage 13.

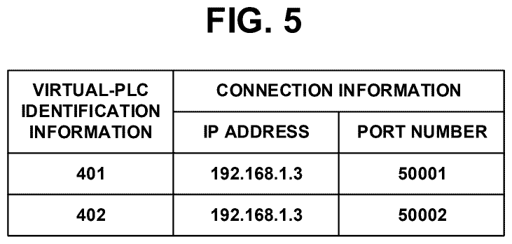

FIG. 5 illustrates examples of the identification information about the virtual PLCs and the connection information stored in the storage 104. The connection information table in FIG. 5 records the virtual-PLC identification information for identifying the virtual PLCs and the connection information including the IP address and the port numbers assigned to the virtual PLCs in a manner associated with each other. The identification information about the first virtual PLC 401 is hereafter referred to as identification information of “401”, and the identification information about the second virtual PLC 402 is hereafter referred to as identification information of “402”. The record in the first row in the connection information table in FIG. 5 indicates that the IP address of “192.168.1.3” and the port number of “50001” are assigned to the first virtual PLC 401 indicated by the virtual-PLC identification information of “401”.

The acquisition request receiver 105 receives, from the engineering tool 300, an acquisition request for the configuration information. The acquisition request receiver 105 is implemented by the processor 11 and the communicator 14. The acquisition request receiver 105 is an example of acquisition request receiving means.

For example, when the user using the engineering tool 300 performs, with the engineering tool 300, an operation for acquiring the configuration information about the virtual PLC system built in the simulation device 100, the engineering tool 300 transmits the acquisition request for the configuration information to the simulation device 100. The acquisition request receiver 105 receives the acquisition request for the configuration information from the engineering tool 300.

The configuration information responder 106 responds to the engineering tool 300 with the configuration information associated with the acquisition request. The configuration information responder 106 is implemented by the processor 11 and the communicator 14. The configuration information responder 106 is an example of configuration information response means.

For example, the configuration information responder 106 responds to the engineering tool 300 with the configuration information 610 about the virtual PLC system 410. When acquiring the configuration information 610, the engineering tool 300 displays the configuration information 610 in FIG. 4 on the screen of the information processing device 500-2.

The designation request receiver 107 receives, from the engineering tool 300, a designation request designating a virtual PLC included in the virtual PLC system indicated by the configuration information. The designation request receiver 107 is implemented by the processor 11 and the communicator 14. The designation request receiver 107 is an example of designation request receiving means.

For example, when the user designates the first virtual PLC 401 in the configuration information 610 displayed on the screen of the information processing device 500-2, the engineering tool 300 transmits the designation request designating the first virtual PLC 401 to the simulation device 100. The designation request receiver 107 receives the designation request designating the first virtual PLC 401 from the engineering tool 300.

The connection information responder 108 responds to the engineering tool 300 with the connection information including the IP address and the port number assigned to the virtual PLC designated in the designation request. The connection information responder 108 is implemented by the processor 11 and the communicator 14. The connection information responder 108 is an example of connection information response means.

For example, the connection information responder 108 refers to the connection information table in FIG. 5 stored in the storage 104 and responds to the engineering tool 300 with the connection information including the IP address of “192.168.1.3” and the port number of “50001” assigned to the first virtual PLC 401.

The simulator 109 causes each virtual PLC in the built virtual PLC system to simulate the operation of the actual PLC. For example, the simulator 109 causes each virtual PLC in the virtual PLC system to simulate remaining on standby for connection with the engineering tool 300 using the assigned IP address and the port number. The simulator 109 also receives, from the engineering tool 300, a connection request including the IP address and the port number assigned to a virtual PLC and causes the virtual PLC to which the IP address and the port number included in the connection request are assigned to simulate connection to the engineering tool 300. The simulator 109 is implemented by the processor 11 and the communicator 14. The simulator 109 is an example of simulation means.

For example, the simulator 109 causes the first virtual PLC 401 to remain on standby for connection with the engineering tool 300 using the IP address of “192.168.1.3” and the port number of “50001”, and causes the second virtual PLC 402 to remain on standby for connection with the engineering tool 300 using the IP address of “192.168.1.3” and the port number of “50002”. When receiving, for example, the connection request including the IP address of “192.168.1.3” and the port number of “50001” from the engineering tool 300, the simulator 109 causes the first virtual PLC 401 to which the IP address of “192.168.1.3” and the port number of “50001” are assigned to simulate connection to the engineering tool 300.

When a virtual PLC included in the virtual PLC system and the engineering tool 300 are connected, subsequent communication between the virtual PLC and the engineering tool 300 is performed without the simulation manager 1001.

The configuration information generator 201 in FIG. 3 generates the configuration information indicating the configuration of the virtual PLC system based on a user operation. The configuration information generator 201 is implemented by the processor 11 and the input device 15. The configuration information generator 201 is an example of configuration information generation means.

For example, the configuration information generator 201 provides a graphical user interface for creating the configuration information about the virtual PLC system and generates the configuration information 610 in FIG. 4 based on the user operation. The configuration information generator 201 then transmits the generated configuration information 610 to the simulation device 100.

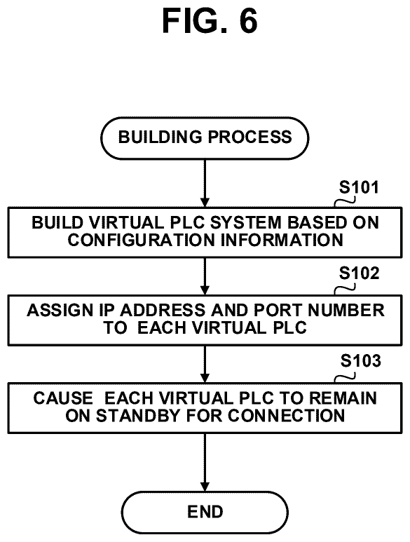

A building process performed by the simulation device 100 according to the present embodiment is now described with reference to the flowchart in FIG. 6. The building process in FIG. 6 is performed when, for example, the configuration information acquirer 101 acquires the configuration information.

The builder 102 builds the virtual PLC system based on the configuration information acquired by the configuration information acquirer 101 (step S101).

For example, when the configuration information acquirer 101 acquires the configuration information 610 in FIG. 4, the builder 102 builds, based on the configuration information 610, the virtual PLC system 410 including the first virtual PLC 401 and the second virtual PLC 402 in the simulation device 100.

The assigner 103 assigns, to each virtual PLC included in the virtual PLC system indicated by the configuration information, the IP address of the information processing device 500-1 in which the simulation device 100 is implemented, and the port number of an unoccupied port of the information processing device 500-1 (step S102).

For example, the assigner 103 assigns the IP address of “192.168.1.3” and the port number of “50001” to the first virtual PLC 401 included in the virtual PLC system 410, and the IP address of “192.168.1.3” and the port number of “50002” to the second virtual PLC 402.

The simulator 109 causes each virtual PLC included in the virtual PLC system built by the builder 102 to remain on standby for connection with the engineering tool 300 using the IP address and the port number assigned by the assigner 103 (step S103).

For example, the simulator 109 causes the first virtual PLC 401 to simulate remaining on standby for connection with the engineering tool 300 using the IP address of “192.168.1.3” and the port number of “50001”, and causes the second virtual PLC 402 to simulate remaining on standby for connection with the engineering tool 300 using the IP address of “192.168.1.3” and the port number of “50002”.

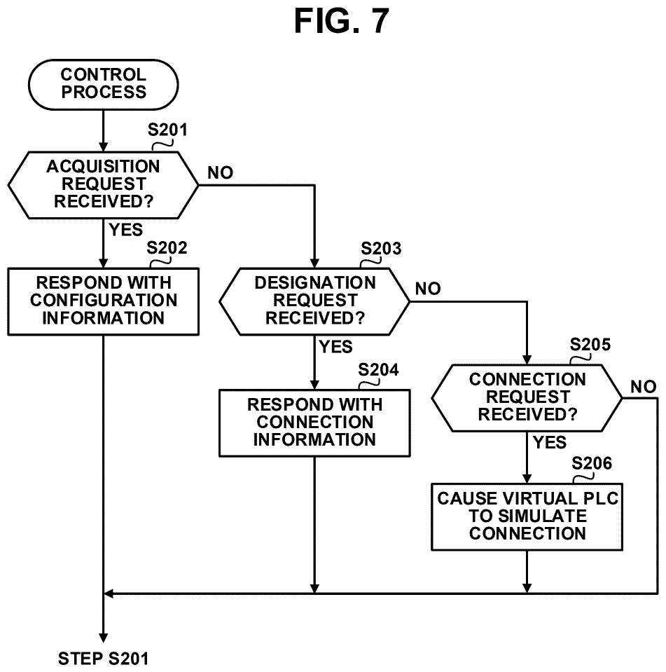

A control process performed by the simulation device 100 according to the present embodiment is now described with reference to the flowchart in FIG. 7. The control process in FIG. 7 is performed when, for example, the builder 102 builds the virtual PLC system based on the configuration information.

The acquisition request receiver 105 determines whether the acquisition request for the configuration information is received from the engineering tool 300 (step S201). When the acquisition request receiver 105 determines that the acquisition request for the configuration information is received from the engineering tool 300 (Yes in step S201), the configuration information responder 106 responds to the engineering tool 300 with the configuration information associated with the acquisition request (step S202). In contrast, when the acquisition request receiver 105 determines that the acquisition request for the configuration information is not received from the engineering tool 300 (No in step S201), the processing advances to step S203.

For example, when the acquisition request receiver 105 determines that the acquisition request for the configuration information is received from the engineering tool 300, the configuration information responder 106 responds to the engineering tool 300 with the configuration information 610 about the virtual PLC system 410. In contrast, when the acquisition request receiver 105 determines that the acquisition request for the configuration information is not received from the engineering tool 300, the processing advances to step S203.

The designation request receiver 107 determines whether the designation request designating a virtual PLC included in the virtual PLC system indicated by the configuration information is received from the engineering tool 300 (step S203). When the designation request receiver 107 determines that the designation request designating a virtual PLC is received (Yes in step S203), the connection information responder 108 responds to the engineering tool 300 with the connection information including the IP address and the port number assigned to the virtual PLC designated in the designation request (step S204). In contrast, when the designation request receiver 107 determines that the designation request designating a virtual PLC is not received (No in step S203), the processing advances to step S205.

For example, when the acquisition request receiver 105 determines that the designation request designating the first virtual PLC 401 is received from the engineering tool 300, the connection information responder 108 refers to the connection information table in FIG. 5 stored in the storage 104 and responds to the engineering tool 300 with the connection information including the IP address of “192.168.1.3” and the port number of in “50001” assigned to the first virtual PLC 401. In contrast, when the acquisition request receiver 105 determines that the designation request designating a virtual PLC is not received from the engineering tool 300, the processing advances to step S205.

The simulator 109 determines whether the connection request including the IP address and the port number assigned to a virtual PLC is received from the engineering tool 300 (step S205). When determining that the connection request including the IP address and the port number assigned to a virtual PLC is received (Yes in step S205), the simulator 109 causes the virtual PLC to which the IP address and the port number included in the connection request are assigned to simulate connecting to the engineering tool 300 (step S206). In contrast, when the simulator 109 determines that the connection request including the IP address and the port number assigned to a virtual PLC is not received (No in step S205), the processing returns to step S201.

For example, when determining that the connection request including the IP address of “192.168.1.3” and the port number of “50001” is received from the engineering tool 300, the simulator 109 causes the first virtual PLC 401 to simulate connecting to the engineering tool 300. In contrast, when the simulator 109 determines that the connection request including the IP address and the port number assigned to a virtual PLC is not received from the engineering tool 300, the processing returns to step S201.

In the present embodiment, the simulation device assigns the IP address and the port number of an unoccupied port to the virtual PLC included in the virtual PLC system. When receiving the connection request for connecting to a specific virtual PLC from the engineering tool, the simulation device responds to the engineering tool with the IP address and the port number for the virtual PLC associated with the connection request. The engineering tool can connect to the specific virtual PLC using the IP address and the port number with which the simulation device has responded. The user can thus easily connect to the virtual PLC without managing information about correspondence of the virtual PLCs with the IP address and the port numbers, or without designating the IP address and the port number of the virtual PLC intended to be connected. The procedural load involved in the simulation can thus be reduced.

In the present embodiment, the engineering tool can connect to each of the multiple virtual PLCs in an information processing device with a single IP address assigned, or in an information processing device with IP addresses fewer than the virtual PLCs assigned. Simulation of the PLC system can thus be performed when the number of the IP addresses assigned to the information processing device is smaller than the number of the PLCs included in the PLC system intended for the simulation.

### Embodiment 2

A simulation system according to Embodiment 2 implements a simulation device using multiple information processing devices and builds virtual PLCs included in the virtual PLC system in the information processing devices to perform distributed simulation.

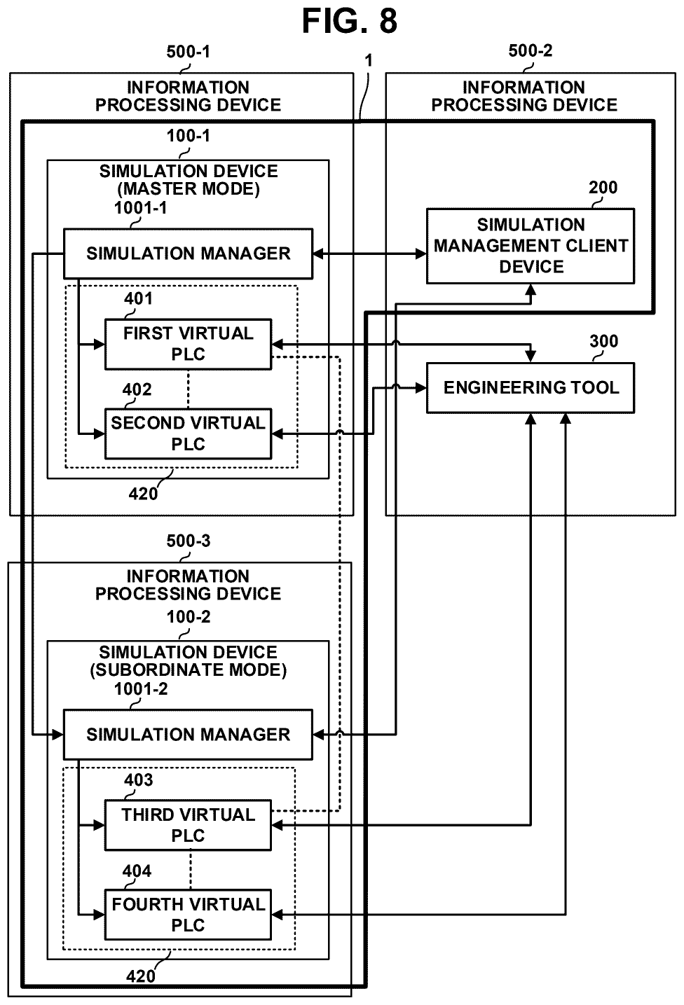

FIG. 8 illustrates a simulation system 1 according to the present embodiment. The simulation system 1 includes multiple simulation devices 100-1 and 100-2, and the simulation management client device 200. The simulation devices 100-1 and 100-2 are connected to each other with a network cable (not illustrated) or wirelessly to allow communication. The simulation devices 100-1 and 100-2 are each connected to the simulation management client device 200 and the engineering tool 300 with a network cable (not illustrated) or wirelessly to allow communication. The simulation devices 100-1 and 100-2 are respectively implemented by the information processing devices 500-1 and 500-3. The simulation management client device 200 and the engineering tool 300 are implemented by the information processing device 500-2.

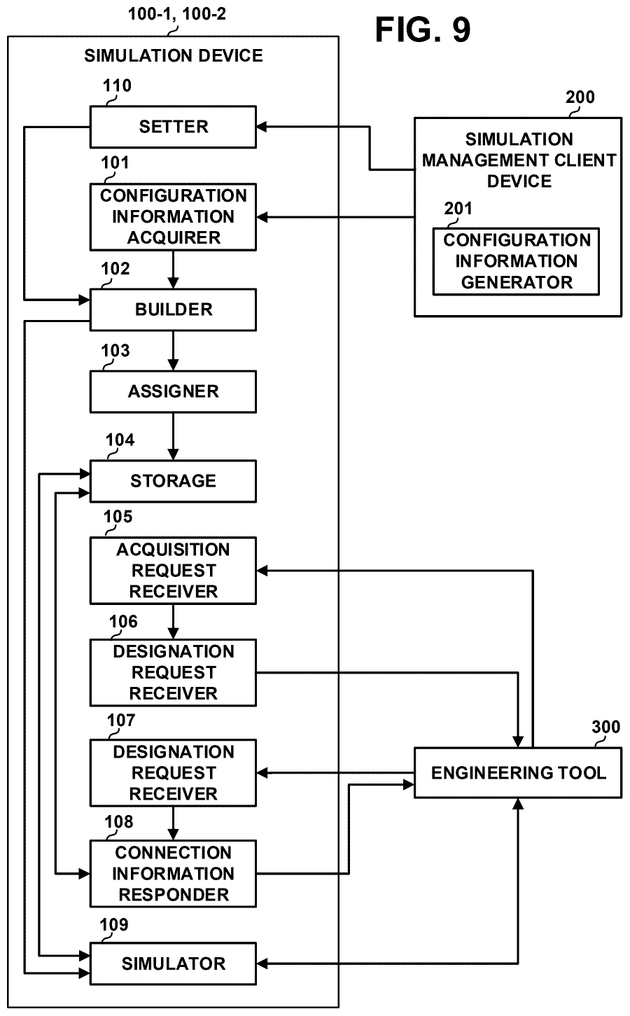

FIG. 9 illustrates functional components of the simulation devices 100-1 and 100-2 and the simulation management client device 200 in the present embodiment.

The simulation devices 100-1 and 100-2 each functionally include, in addition to the components included in the simulation device according to Embodiment 1, a setter 110 that sets the simulation device to a master mode or a subordinate mode. The setter 110 is a function of simulation managers 1001-1 and 1001-2. The functions of the simulation devices 100-1 and 100-2 different from the functions of the simulation devices according to Embodiment 1 are described below.

The setter 110 sets the simulation device to the master mode to cause a simulation device different from the simulation device to build a virtual PLC, or to the subordinate mode to build a virtual PLC as instructed by a simulation device different from the simulation device. The setter 110 is implemented by the processor 11 and the communicator 14. The setter 110 is an example of setting means.

For example, the simulation management client device 200 receives, from a user, an operation to set the simulation device 100-1 implemented by the information processing device 500-1 to the master mode and the simulation device 100-2 implemented by the information processing device 500-3 to the subordinate mode. The simulation management client device 200 transmits, to the simulation device 100-1 implemented by the information processing device 500-1, a setting request for setting the master mode, and the setter 110 in the simulation device 100-1 sets the simulation device 100-1 to the master mode. The simulation management client device 200 transmits, to the simulation device 100-2 implemented by the information processing device 500-3, a setting request for setting the subordinate mode, and the setter 110 in the simulation device 100-2 sets the simulation device 100-2 to the subordinate mode.

The simulation device 100-1 set in the master mode functions as, in addition to the setter 110, the configuration information acquirer 101, the builder 102, the assigner 103, the storage 104, the acquisition request receiver 105, the configuration information responder 106, the designation request receiver 107, the connection information responder 108, and the simulator 109. The simulation device 100-2 set in the subordinate mode functions as, in addition to the setter 110, the builder 102, the assigner 103, and the simulator 109.

The configuration information acquirer 101 in the simulation device 100-1 acquires the configuration information.

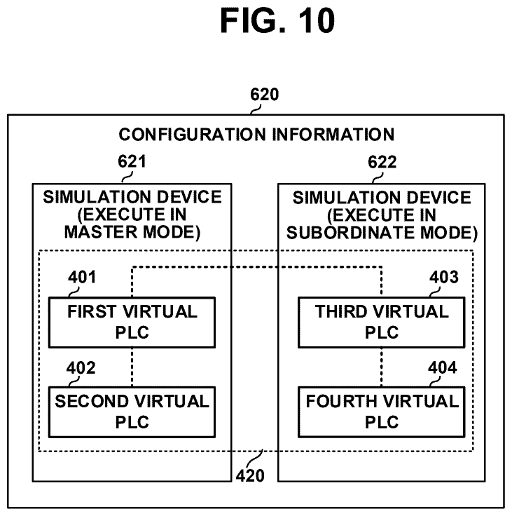

For example, the configuration information acquirer 101 acquires configuration information 620 in FIG. 10 from the simulation management client device 200. The configuration information 620 is information indicating the configuration of a virtual PLC system 420 including the first virtual PLC 401, the second virtual PLC 402, a third virtual PLC 403, and a fourth virtual PLC 404. The configuration information 620 includes information items 621 and 622 indicating a virtual PLC in the virtual PLC system 420 to be executed by the simulation device in the master mode and a virtual PLC to be executed by the simulation device in the subordinate mode.

The builder 102 in the simulation device 100-1 causes the simulation device 100-2 set in the subordinate mode to build at least one of the virtual PLCs included in the virtual PLC system indicated by the configuration information acquired by the configuration information acquirer 101.

For example, the builder 102 in the simulation device 100-1 builds, based on the configuration information 620, the first virtual PLC 401 and the second virtual PLC 402 on the simulation device 100-1 in the master mode. The builder 102 in the simulation device 100-1 transmits, based on the configuration information 620, an instruction to cause the simulation device 100-2 in the subordinate mode to build the third virtual PLC 403 and the fourth virtual PLC 404.

The assigner 103 in the simulation device 100-1 assigns, to each virtual PLC built on the simulation device 100-1 set in the master mode, the IP address of the simulation device 100-1 set in master mode and the port number of an unoccupied port in the simulation device 100-1 set in master mode.

For example, the assigner 103 in the simulation device 100-1 assigns the IP address of “192.168.1.3” and the port number of “50001” to the first virtual PLC 401, and the IP address of “192.168.1.3” and the port number of “50002” to the second virtual PLC 402.

The builder 102 in the simulation device 100-2 builds, as instructed by the simulation device 100-1 set in the master mode, at least one of the virtual PLCs in the virtual PLC system.

For example, the builder 102 in the simulation device 100-2 builds the third virtual PLC 403 and the fourth virtual PLC 404 on the simulation device 100-2 in the subordinate mode.

The assigner 103 in the simulation device 100-2 assigns, to each virtual PLC built on the simulation device 100-2 set in the subordinate mode, the IP address of the simulation device 100-2 set in the subordinate mode and the port number of an unoccupied port of the simulation device 100-2 set in the subordinate mode.

For example, the IP address of the information processing device 500-3 is “192.168.1.4”, and the port numbers of unoccupied ports of the information processing device 500-3 are “50001” to “50100”. The assigner 103 in the simulation device 100-2 assigns the IP address of “192.168.1.4” and the port number of “50001” to the third virtual PLC 403, and the IP address of “192.168.1.4” and the port number of “50002” to the fourth virtual PLC 404.

The assigner 103 in the simulation device 100-1 acquires information about the IP address and the port number assigned to each virtual PLC built on the simulation device 100-2 set in the subordinate mode.

For example, the assigner 103 in the simulation device 100-1 acquires information about the IP address of “192.168.1.4” and the port number of “50001” assigned to the third virtual PLC 403, and the IP address of “192.168.1.4” and the port number of “50002” assigned to the fourth virtual PLC 404. The assigner 103 in the simulation device 100-1 then stores, into the storage 104 in the simulation device 100-1, the virtual-PLC identification information and the connection information about the third virtual PLC 403 and the fourth virtual PLC 404.

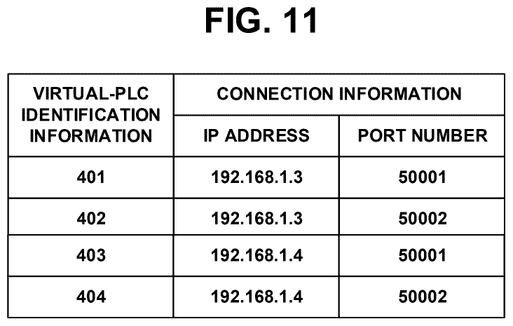

FIG. 11 illustrates examples of the virtual-PLC identification information and the connection information stored in the storage 104 in the simulation device 100-1. The virtual-PLC identification information about the third virtual PLC 403 is hereafter referred to as identification information of “403”, and the virtual-PLC identification information about the fourth virtual PLC 404 is hereafter referred to as identification information of “404”. The connection information table in FIG. 11 records, in a manner associated with each other, the virtual-PLC identification information and the connection information about each of the first virtual PLC 401, the second virtual PLC 402, the third virtual PLC 403, and the fourth virtual PLC 404.

The simulator 109 in the simulation device 100-1 causes the first virtual PLC 401 to remain on standby for connection with the engineering tool 300 using the IP address of “192.168.1.3” and the port number of “50001”, and causes the second virtual PLC 402 to remain on standby for connection with the engineering tool 300 using the IP address of “192.168.1.3” and the port number of “50002”. The simulator 109 in the simulation device 100-2 also causes the third virtual PLC 403 to remain on standby for connection with the engineering tool 300 using the IP address of “192.168.1.4” and the port number of “50001”, and causes the fourth virtual PLC 404 to remain on standby for connection with the engineering tool 300 using the IP address of “192.168.1.4” and the port number of “50002”.

The acquisition request receiver 105 in the simulation device 100-1 receives, from the engineering tool 300, the acquisition request for the configuration information. The configuration information responder 106 in the simulation device 100-1 responds to the engineering tool 300 with the configuration information associated with the acquisition request.

For example, when the acquisition request receiver 105 in the simulation device 100-1 receives, from the engineering tool 300, the acquisition request for the configuration information, the configuration information responder 106 in the simulation device 100-1 responds to the engineering tool 300 with the configuration information 620 about the virtual PLC system 420. When acquiring the configuration information 620, the engineering tool 300 displays the configuration information 620 in FIG. 10 on the screen of the information processing device 500-2.

The designation request receiver 107 in the simulation device 100-1 receives, from the engineering tool 300, the designation request designating a virtual PLC built on the simulation device 100-2 among the virtual PLCs included in the virtual PLC system indicated by the configuration information.

For example, when the user designates the third virtual PLC 403 in the configuration information 620 displayed on the screen of the information processing device 500-2, the engineering tool 300 transmits the designation request designating the third virtual PLC 403 to the simulation device 100-1, and the designation request receiver 107 in the simulation device 100-1 receives the designation request designating the third virtual PLC 403 from the engineering tool 300.

The connection information responder 108 in the simulation device 100-1 responds to the engineering tool 300 with the connection information including the IP address and the port number assigned to the virtual PLC built on the simulation device 100-2 and designated in the designation request.

For example, the connection information responder 108 in the simulation device 100-1 refers to the connection information table in FIG. 11 stored in the storage 104 and responds to the engineering tool 300 with the connection information including the IP address of “192.168.1.4” and the port number of “50001” assigned to the third virtual PLC 403.

When, for example, the connection request including the IP address of “192.168.1.4” and the port number of “50001” is received from the engineering tool 300, the simulator 109 in the simulation device 100-2 causes the third virtual PLC 403 to which the IP address of “192.168.1.4” and the port number of “50001” are assigned to simulate connecting to the engineering tool 300.

A building process and a control process performed by each of the simulation devices 100-1 and 100-2 according to the present embodiment are now described.

The simulation device 100-1 in the master mode performs the same processing as in the building process in FIG. 6. The simulation device 100-2 in the subordinate mode performs the same processing as in steps S102 and S103 in FIG. 6, but performs different processing from the processing in step S101. The builder 102 in the simulation device 100-2 builds the virtual PLC system as instructed by the simulation device 100-1 in the master mode. The simulation device 100-2 then performs processing in steps S102 and S103.

The simulation device 100-1 in the master mode performs the same processing as in the control process in FIG. 7. The simulation device 100-2 in the subordinate mode simply performs processing in steps S205 and S206 in FIG. 7.

In the present embodiment, the user can easily connect to a virtual PLC in the virtual PLC system built in multiple simulation devices without managing information about correspondence of the virtual PLCs with the IP addresses and the port numbers, or without designating the IP address and the port number of the virtual PLC intended to be connected. The procedural load involved in the simulation can thus be reduced.

### Embodiment 3

A simulation system according to Embodiment 3 assigns, to each virtual PLC, destination identification information for identifying the destination of a processing request, instead of the IP address and a port number.

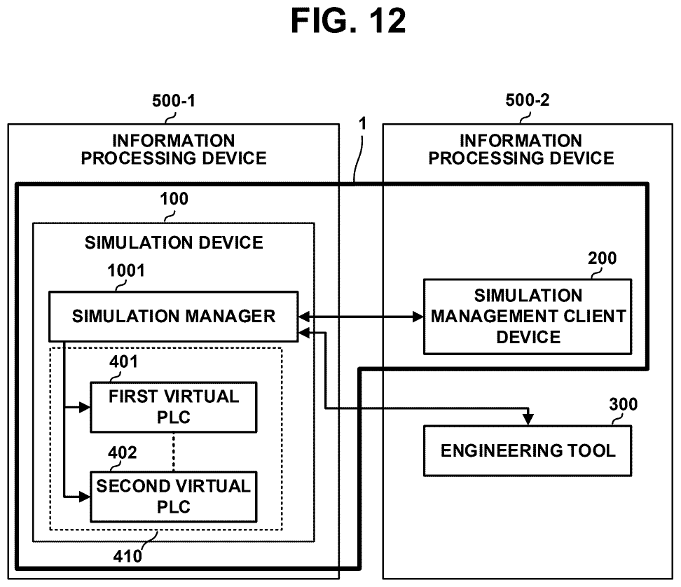

FIG. 12 illustrates a simulation system 1 according to the present embodiment. The simulation system 1 according to the present embodiment has the same structure as in Embodiment 1, but the engineering tool 300 connects to a virtual PLC in the virtual PLC system 410 through the simulation manager 1001. Additionally, the engineering tool 300 connects to the simulation device 100 using the IP address and a predetermined port number of the information processing device 500-1 in which the simulation device 100 is implemented. For example, the engineering tool 300 connects to the simulation device 100 using the IP address of “192.168.1.3” and the port number of “50003”.

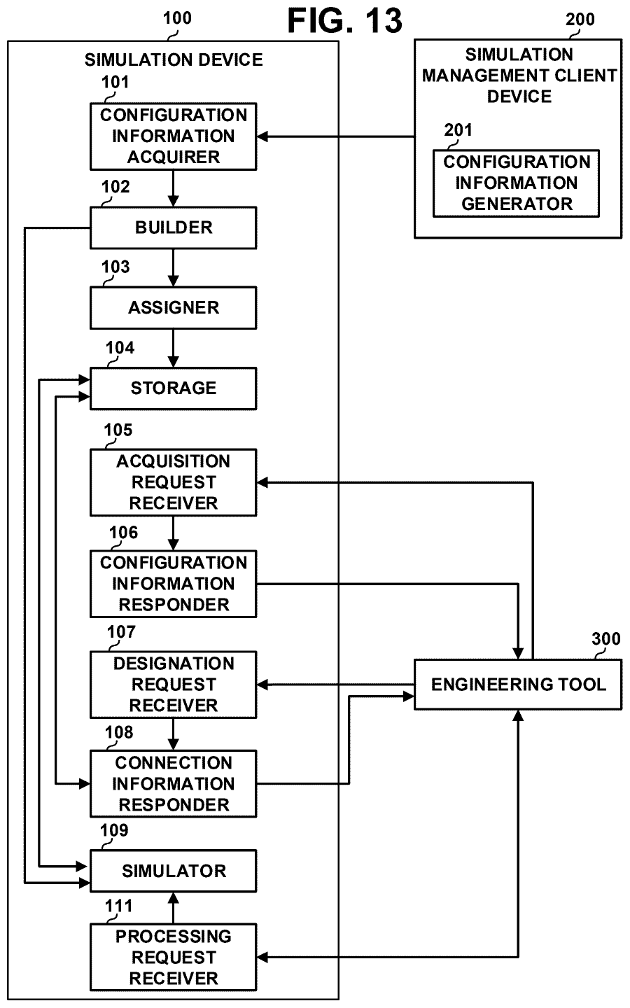

FIG. 13 illustrates functional components of the simulation device 100 and the simulation management client device 200 in the present embodiment.

The simulation device 100 functionally includes, in addition to the components included in the simulation device according to Embodiment 1, a processing request receiver 111 that receives, from the engineering tool 300, a processing request to a virtual PLC. The processing request receiver 111 is a function of the simulation manager 1001. The functions different from the functions of the simulation device according to Embodiment 1 are described below. In the embodiment, the configuration information acquirer 101 acquires the configuration information 610 in FIG. 4.

The assigner 103 assigns, to each virtual PLC included in the virtual PLC system indicated by the configuration information, destination identification information for identifying the destination of the processing request requesting the virtual PLC to perform processing.

The processing request is a request designating details of processing to be performed in a virtual PLC and transmitted from the engineering tool 300 to the simulation device 100. The destination identification information identifies the destination of the processing request, and the destination is a virtual PLC included in the virtual PLC system.

For example, the assigner 103 assigns the destination identification information of “aaa” to the first virtual PLC 401, and the destination identification information of “bbb” to the second virtual PLC 402.

When assigning the destination identification information to the virtual PLCs, the assigner 103 stores the destination identification information, as the connection information, into the storage 104.

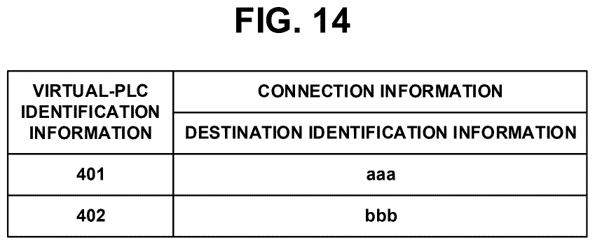

FIG. 14 illustrates examples of the identification information and the connection information about the virtual PLCs stored in the storage 104. The connection information table in FIG. 14 records the virtual-PLC identification information for identifying each virtual PLC and the connection information being the destination identification information assigned to the virtual PLC in a manner associated with each other. The record in the first row in the connection information table in FIG. 14 indicates that the destination identification information of “aaa” is assigned to the first virtual PLC 401 indicated by the virtual-PLC identification information of “401”.

The connection information responder 108 responds to the engineering tool 300 with the connection information being the destination identification information assigned to the virtual PLC designated in the designation request.

For example, when the operation of designating the first virtual PLC 401 is performed on the configuration information 610 displayed on the screen of the information processing device 500-2, the engineering tool 300 transmits the designation request designating the first virtual PLC 401 to the simulation device 100, and the designation request receiver 107 receives the designation request designating the first virtual PLC 401 from the engineering tool 300. The connection information responder 108 refers to the connection information table in FIG. 14 stored in the storage 104 and responds to the engineering tool 300 with the connection information including the destination identification information of “aaa” assigned to the first virtual PLC 401.

When transmitting the processing request requesting the virtual PLC to perform processing, the engineering tool 300 incorporates, into the processing request, the destination identification information assigned to the virtual PLC to which processing is requested.

When receiving, from the engineering tool 300, the processing request including the destination identification information associated with the connection request with which the connection information responder 108 has responded, the processing request receiver 111 transmits the processing request to the virtual PLC to which the destination identification information included in the processing request is assigned. The processing request receiver 111 is implemented by the processor 11 and the communicator 14. The processing request receiver 111 is an example of processing request receiving means.

For example, when receiving a processing request A including the destination identification information of “aaa” from the engineering tool 300, the processing request receiver 111 refers to the connection information table in FIG. 14, identifies the first virtual PLC 401 associated with the destination identification information of “aaa” as the destination of the processing request A, and transmits the processing request A to the first virtual PLC 401.

The simulator 109 then causes the virtual PLC to which the destination identification information included in the processing request is assigned to simulate performing processing indicated by the processing request.

For example, the simulator 109 causes the first virtual PLC 401 to simulate performing processing indicated by the processing request A. The processing request receiver 111 transmits the processing request to the simulator 109 with any method.

A building process and a control process performed by the simulation device 100 according to the present embodiment are now described.

The simulation device 100 performs the same processing as in steps S101 and S103 in FIG. 6, but performs different processing from the processing in step S102. After the processing in step S101, the assigner 103 in the simulation device 100 assigns the destination identification information to the virtual PLCs included in the virtual PLC system indicated by the configuration information. The simulation device 100 then performs the processing in step S103.

The simulation device 100 performs different processing in steps S205 and S206 in FIG. 7 alone. The processing request receiver 111 in the simulation device 100 determines whether the connection request including the destination identification information is received from the engineering tool 300. When determining that the processing request including the destination identification information is received, the processing request receiver 111 transmits the processing request to the virtual PLC to which the destination identification information included in the processing request is assigned.

In the information processing devices that implements the simulation device, various services use ports of the information processing device to operate. The information processing device may thus not have enough ports to assign to the virtual PLCs in the virtual PLC system, depending on the operation state of such services. In the present embodiment, however, the destination identification information for identifying the destination is assigned to each virtual PLC, and the engineering tool can connect to a specific virtual PLC using the destination identification information. With a single port number used in the present embodiment, a simulation can be performed by the virtual PLC system when the unoccupied ports of the information processing device are fewer than the virtual PLCs and cannot be prepared as many as the virtual PLCs.

### Modifications

Although the embodiments of the present disclosure have been described above, the embodiments of the present disclosure may be modified or applied in various manners to implement the present disclosure.

In the above embodiments, the simulation management client device 200 is implemented in an information processing device different from the simulation device 100, but may be implemented differently. The simulation device 100 and the simulation management client device 200 may be implemented in the same information processing device.

In the above embodiments, the simulation management client device 200 is implemented in the same information processing device in which the engineering tool 300 is implemented, but may be implemented differently. The simulation management client device 200 and the engineering tool 300 may be implemented in different information processing devices.

In Embodiment 2, the simulation device is implemented by two information processing devices, but may be implemented by three or more information processing devices. In this case, one of the multiple information processing devices is set to the master mode, and the other information processing devices are set to the subordinate mode.

The operation program describing the operation of the simulation device 100 according to the above embodiments may be used for an existing personal computer or an existing information terminal device to allow the personal computer or the information terminal device to function as the simulation device 100.

Such a program may be distributed in any manner. For example, the program may be distributed as being stored in a non-transitory computer-readable recording medium such as a compact disk read-only memory (CD-ROM), a digital versatile disc (DVD), or a memory card, or may be distributed through a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure may provide a simulation program, a simulation device, a simulation system, and a simulation method that can easily connect to a virtual PLC.

### REFERENCE SIGNS LIST

1 Simulation system
11 Processor
12 Main storage
13 Auxiliary storage
14 Communicator
15 Input device
16 Output device
17 Bus
100, 100-1, 100-2 Simulation device
101 Configuration information acquirer
102 Builder
103 Assigner
104 Storage
105 Acquisition request receiver
106 Configuration information responder
107 Designation request receiver
108 Connection information responder
109 Simulator
110 Setter
111 Processing request receiver
200 Simulation management client device
201 Configuration information generator
300 Engineering tool
401 First virtual PLC
402 Second virtual PLC
403 Third virtual PLC
404 Fourth virtual PLC
410, 420 Virtual PLC system
500, 500-1, 500-2, 500-3 Information processing device
610, 620 Configuration information
621, 622 Information item
1001, 1001-1, 1001-2 Simulation manager

1. A non-transitory computer-readable recording medium storing a simulation program, the simulation program causing a computer to perform operations comprising:
acquiring configuration information indicating a configuration of a virtual PLC system to simulate an operation of a PLC system, the PLC being a programmable logic controller;
building the virtual PLC system based on the configuration information;
assigning, to a virtual PLC included in the virtual PLC system indicated by the configuration information, an internet protocol address of the computer and a port number of an unoccupied port of the computer;
receiving, from an engineering tool implemented by a different computer different from the computer, a designation request designating the virtual PLC included in the virtual PLC system indicated by the configuration information and not including the internet protocol address and the port number; and
responding to the engineering tool with connection information including the internet protocol address and the port number assigned to the virtual PLC designated in the designation request.

2. The recording medium according to claim 1, wherein the simulation program further causes the computer to perform operations comprising:
receiving, from the engineering tool, a connection request including the internet protocol address and the port number assigned to the virtual PLC, and causing the virtual PLC to which the internet protocol address and the port number included in the connection request are assigned to simulate connecting to the engineering tool.

3. The recording medium according to claim 1, wherein the simulation program further causes the computer to perform operations comprising:
setting the computer to a master mode to cause a different computer different from the computer to build the virtual PLC as instructed by the computer, or to a subordinate mode to build the virtual PLC as instructed by the different computer;
when the computer is set in the master mode,
acquiring the configuration information,
causing the different computer set in the subordinate mode to build at least one of a plurality of the virtual PLCs included in the virtual PLC system indicated by the acquired configuration information,
assigning, to the virtual PLC built on the computer set in the master mode, an internet protocol address of the computer set in the master mode and a port number of an unoccupied port of the computer set in the master mode,
acquiring information about an internet protocol address and a port number assigned to the at least one virtual PLC built on the different computer set in the subordinate mode,
receiving, from the engineering tool, the designation request designating the at least one virtual PLC built on the different computer among the plurality of virtual PLCs included in the virtual PLC system indicated by the configuration information, and
responding to the engineering tool with the connection information including the internet protocol address and the port number assigned to the at least one virtual PLC built on the different computer and designated in the designation request; and
when the computer is set in the subordinate mode,
building, as instructed by the different computer set in the master mode, at least one of the plurality of virtual PLCs in the virtual PLC system, and
assigning, to the at least one virtual PLC built on the computer set in the subordinate mode, an internet protocol address of the computer set in the subordinate mode and a port number of an unoccupied port of the computer set in the subordinate mode.

4.-5. (canceled)

6. The recording medium according to claim 1, wherein the simulation program further causes the computer to perform operations comprising:
receiving, from the engineering tool, an acquisition request for the configuration information; and
responding to the engineering tool with the configuration information associated with the acquisition request,
wherein the engineering tool receives a selection of the virtual PLC included in the virtual PLC system indicated by the configuration information with which the responding has been performed, and transmits the designation request designating the virtual PLC indicated in the received selection.

7. A simulation device, comprising:
a storage; and
processing circuitry to
acquire configuration information indicating a configuration of a virtual PLC system to simulate an operation of a PLC system, the PLC being a programmable logic controller;
build the virtual PLC system based on the configuration information;
assign, to a virtual PLC included in the virtual PLC system indicated by the configuration information, an internet protocol address and a port number, the internet protocol address being an internet protocol address of an information processing device in which the simulation device to build the virtual PLC system is implemented, the port number being a port number of an unoccupied port of the information processing device;
receive, from an engineering tool implemented by a different information processing device different from the information processing device, a designation request designating the virtual PLC included in the virtual PLC system indicated by the configuration information and not including the internet protocol address and the port number; and
respond to the engineering tool with connection information including the internet protocol address and the port number assigned to the virtual PLC designated in the designation request.

8. (canceled)

9. A simulation system, comprising:
a first storage;
a second storage;
first processing circuitry to generate, based on a user operation, configuration information indicating a configuration of a virtual PLC system to simulate an operation of a PLC system, the PLC being a programmable logic controller; and
second processing circuitry to
acquire the configuration information,
build the virtual PLC system based on the configuration information,
assign, to a virtual PLC included in the virtual PLC system indicated by the configuration information, an internet protocol address and a port number, the internet protocol address being an internet protocol address of an information processing device in which a simulation device to build the virtual PLC system is implemented, the port number being a port number of an unoccupied port of the information processing device,
receive, from an engineering tool implemented by a different information processing device different from the information processing device, a designation request designating the virtual PLC included in the virtual PLC system indicated by the configuration information and not including the internet protocol address and the port number, and
respond to the engineering tool with connection information including the internet protocol address and the port number assigned to the virtual PLC designated in the designation request.

10.-12. (canceled)

13. The recording medium according to claim 2, wherein the simulation program further causes the computer to perform operations comprising:
setting the computer to a master mode to cause a different computer different from the computer to build the virtual PLC as instructed by the computer, or to a subordinate mode to build the virtual PLC as instructed by the different computer;
when the computer is set in the master mode,
acquiring the configuration information,
causing the different computer set in the subordinate mode to build at least one of a plurality of the virtual PLCs included in the virtual PLC system indicated by the acquired configuration information,
assigning, to the virtual PLC built on the computer set in the master mode, an internet protocol address of the computer set in the master mode and a port number of an unoccupied port of the computer set in the master mode,
acquiring information about an internet protocol address and a port number assigned to the at least one virtual PLC built on the different computer set in the subordinate mode,
receiving, from the engineering tool, the designation request designating the at least one virtual PLC built on the different computer among the plurality of virtual PLCs included in the virtual PLC system indicated by the configuration information, and
responding to the engineering tool with the connection information including the internet protocol address and the port number assigned to the at least one virtual PLC built on the different computer and designated in the designation request; and
when the computer is set in the subordinate mode,
building, as instructed by the different computer set in the master mode, at least one of the plurality of virtual PLCs in the virtual PLC system, and
assigning, to the at least one virtual PLC built on the computer set in the subordinate mode, an internet protocol address of the computer set in the subordinate mode and a port number of an unoccupied port of the computer set in the subordinate mode.

14. The recording medium according to claim 2, wherein the simulation program further causes the computer to perform operations comprising:
receiving, from the engineering tool, an acquisition request for the configuration information; and
responding to the engineering tool with the configuration information associated with the acquisition request,
wherein the engineering tool receives a selection of the virtual PLC included in the virtual PLC system indicated by the configuration information with which the responding has been performed, and transmits the designation request designating the virtual PLC indicated in the received selection.

15. The recording medium according to claim 3, wherein the simulation program further causes the computer to perform operations comprising:
receiving, from the engineering tool, an acquisition request for the configuration information; and
responding to the engineering tool with the configuration information associated with the acquisition request,
wherein the engineering tool receives a selection of the virtual PLC included in the virtual PLC system indicated by the configuration information with which the responding has been performed, and transmits the designation request designating the virtual PLC indicated in the received selection.
